(19) United States
(12) Patent Application Publication
(10) Pub. No.: US 2006/0265302 A1
(43) Pub. Date: Nov. 23, 2006

(54) Data management for use in capital market indexes

(75) Inventors: Warren F. Schmalenberger, Houston, TX (US); Joshua J. Perryman, Bryan, TX (US); Brandon L. Wallace, Houston, TX (US); Matthew A. Lott, Richmond, TX (US)

Correspondence Address: Mark R. Wisner;Wisner & Associates, Suite 400, 1177 West Loop South, Houston, TX, 77027-9012, US

(73) Assignee: Dorchester Capital Management Company

(21) Appl. No.: 11/414,870

(22) Filed: May 1, 2006

Related U.S. Application Data
(63) Continuation-in-part of application No. 09/442,819, filed on Nov. 18, 1999.

(51) Int. Cl. G06Q 40/00

(52) U.S. Cl. 705/35

(57) ABSTRACT

A method of for construction a database to support calculation of capital market indexes. The method includes treatment of all securities in the financial markets and utilizes criteria for selecting subsets of types of securities and weighting the market value of said securities to provide said selected and weighted securities to market index calculations. Data from identified vendors is collected, standardized as to terminology, corrected for omissions and other errors, formatted in standard digital form and stored compactly in digital storage media. Several of the indexes require updates on a frequency as great as once every fifteen seconds as utilized in the preferred embodiment. Others of the indexes require data updated on a daily or less frequent basis. Historical data is included to provide a long baseline for index calculation.

The present invention is a Continuation-in-Part application of U.S. patent application Ser. No. 09/442,819, filed Nov. 18, 1999 and entitled, “Capital Market Index.” (the “819” patent application), which application is hereby incorporated into this specification in its entirety by this specific reference thereto. The '819 application was converted from a provisional application of the same title filed on Nov. 20, 1998.

### BACKGROUND OF THE INVENTION

The present invention relates to a computer based method for selecting securities, identifying data elements comprehensively describing each security, acquiring the data elements, formatting the data elements for storage and utilization to compute capital market indexes.

The 819 patent application teaches a method of computing a capital market index which represents the “capital market portfolio” of one or more countries. The capital market index is useful as both an investment and an analytical tool.

The capital market includes bond, money market and equity or stocks. Each of these capital market segments is regulated, managed and tracked using different mechanics and methodologies. Each has its own unique risk/return characteristics and historical performance.

A market index is an investment and analysis tool useful in measuring present market conditions and changing market conditions. A perfect index would dynamically replicate the entire marketplace and would enable the goal of measuring improvements in marketplace performance. A complete index requires the use of a “market portfolio” which can account for all sectors of the economy. This index can accurately reflect the performance of the marketplace.

In efforts to measure, compare and track the growth/decline in investments, students of the markets commonly use indexes as benchmarks. Generally speaking, several indexes have been established for measuring various subsections of the marketplace. For example, the Dow Jones Industrial Average computes an index (based on a stock portfolio selected by Dow Jones) used to measure the equity market. Additionally, the Wilshire 5000 computes an equity index based upon a selected stock portfolio. Similar indexes exist for measuring the bond market and the money market. For instance, Lehman Bros. computes and publishes several bond market indexes and the IBC's Money Fund Report is published as a measure of the money market.

Work on the flow of funds accounts at the Board of Governors of the Federal Reserve System dates back to 1947. The Board's first publication of the accounts, with annual data was in 1955, and the first set of accounts with quarterly data appeared in the August 1959 Federal Reserve Bulletin. From the onset, the emphasis in this publication was providing statements of total sources of funds flowing to economic sectors and the use of funds in the various sectors. The flow of funds accounts have also been closely tied to the national income and product accounts, published by the Bureau of Economic Analysis in the U.S. Department of commerce. The structure of the flow of funds accounts has evolved to reflect innovations in financial instruments and the emergence of new institutions.

However, because each of the above mentioned indexes only measures a subsection of the marketplace, even when taken together, they cannot account for the grouping of different types of financial assets. Further, they cannot account for additions and subtractions between major classes of assets or into or out of the aggregate capital market. For example, if an investor removes capital from the stock market and reinvests into the bond market, an index such as the Wilshire 5000 will only indicate that there was a decrease in capital invested in the equity market. The Wilshire 5000 cannot account for the shifting of capital between markets. Thus, an index such as the Wilshire 5000 cannot provide an accurate picture of the entire marketplace.

More critically, the data describing the performance of various market subsets is collected and held by different institutions with different, historically based formats, and is assembled for differing time periods. There is no single, central source for all the data and the formats do not share a common denominator that would facilitate examination and comparison.

The value of being able to track the marketplace more accurately is evidenced by the number of prior art methods and inventions related to portfolio management which were discussed in the 819 application. The significance of the instant invention is the depiction of the construction and management of a unique database not previously disclosed which enables the construction and use of the capital markets indexes disclosed in the 819 application.

In addition to the prior art methods and inventions discussed in the background of the '819 application, there are several patents and other existing art which address issues of financial database formation. U.S. Pat. No. 6,850,906 (Chadha et al.) discloses a real-time financial search engine which retrieves financial updates in real-time and then stores the updates. Users of this system may search this real time data using a symbol and a time. The Chadha patent does not teach the construction of a managed database with multiple entities nor does it teach criteria for selecting individual financial instruments for use in calculation of indexes.

The system of the instant invention stores a considerable amount of data for the purpose of calculating market indexes. This data includes not only price, volume and date, but also records which describe the security, actions taken by issuers and/or purchasers to change the security's characteristics. The emphasis is on the sequential nature of the information—i.e. March 2^{nd} comes after March 1^{st}.

The real time data flow has time stamps on the prices of the securities. This practice was established prior to the filing of the Chadha patent and is an industry convention in mediums such as the “Consolidate Tape” which transmits stock market information.

The system of the instant invention provides the capability to search the database created by the system for specific information which would include the price of a security and it symbol as well as its daily volume. As such, the system of the instant invention exceeds the capabilities of a search engine.

U.S. Pat. No. 6,925,441 (Jones, et al.) discloses a system and method of targeted marketing to consumers, including businesses and associates, based upon the financial characteristics of the consumer, type offer being made and the channel of communication for delivery of the offer. The consumer is characterized based upon financial, behavioral, and socioeconomic factors. The offer is characterized based upon the consumer and the potential for the consumer accepting the offer. The channel of communication for delivery of the offer is also characterized and combined with the consumer and consumer-offer characteristics to arrive at a net present value of the offer to be made. The system of the instant invention is directed toward measuring the different activities in the security markets as they occur and not the possibilities that could occur as directed toward consumers with particular economic status as in the Jones patent. Further, the method of the instant invention does not consolidate, monitor or control financial transactions of a given entity.

European patent EP1109122 (Li, et al.) discloses a data system to analyze and chart the price activities of an instrument or commodity traded in a market. The system disclosed in the Li patent examines the changes in the price of a security relative to a pre-determined level. In contrast, the system of the instant invention provides calculations of the changes in the total return of the securities including monies received as dividends or coupon interest payments. Further, after calculating and storing the total returns of individual securities, the system of instant invention combines these returns into quantities reflecting calculated portfolio returns through time. Then the portfolio returns are standardized by an index value set at a level of 10000 for the date of Dec. 31, 1999. These operations require many more calculations than simply examining relative price determinations as in the Li patent which does not teach any kind of index creation.

European patent EP1122661 (Pellegrinelli, et al.) discloses a method of distributing performance data concerning a plurality of subjects such as stock market companies from a distribution site to a user site. The Pellegrinelli patent teaches data condensation, recognizes the “data gathering companies” and utilizes their data but teaches data condensation for efficiency in transmission. By contrast, the system of the instant invention aggregates data for the purpose of utilizing it to calculate performance indexes which is not taught by Pellegrinelli.

U.S. Pat. No. 6,236,972 (Shkedy) discloses a method and device for using a computer to facilitate a transaction of secondary market shares of an investment company between a buyer and a seller. The method and computer support of the system of the instant invention gathers data for different activities in the security markets as they occur. The Shkedy patent utilizes a database for the purpose of matching “buy and sell orders” and does not contemplate or teach the acquisition and use of data for calculation of indexes.

Each of the above discussed patents discloses the creation of or use of financial databases for reference or analysis purposes but none possesses the scope or purpose of the databases claimed by the instant invention. These patents disclose databases applicable to limited portfolios which only relate to a specific portion of the market rather than the entire marketplace or a use of databases disparate from the syntheses of databases to be used in the indexes disclosed in the '819 application. The indexes of the '819 application constitute an investment manager utilizing the entire marketplace and are thus able to more accurately depict the current state of the market in relationship to the economy.

There are a number of financial databases in use and, while they are not patented, they do depict a representative profile of the existing art. None of the following databases is constructed with the purpose of using the data for constructing the kind of comprehensively based capital market indexes disclosed in the '819 patent application. The following databases display neither the breadth of coverage of the instant invention nor the other attributes necessary for the construction of said capital market indexes.

The DRI Financial Markets Indexes provide information only about the fixed income markets but this service does not calculate indexes with the breadth and coverage as the instant invention. DRI's use of the word “indexes” refers to the services indexing the financial data for search purposes in finding data for a particular entity.

Barra Global Investment Technology has a product denoted “Barra's TotalRisk System.” This system is a bottom-up approach to construct a database which covers a sub-set of the Standard and Poors indexes including stocks, bonds, exchange-traded and over the counter (OTC) derivatives, mortgage and asset backed securities, inflation protected bonds, money market instruments and structured products. The depth of the information is not disclosed to the observer and the information presented is not further utilized to construct a market index which the user may employ to test his portfolio. The Barra information is presented in different formats and does not lend itself to ready calculation by the user who would have to decide how to construct and test his own, subjective index without the utility of the standard provided by the instant invention.

ECONData provides a useful tool for finding publicly available databases in a manner similar to GlobalInsight. However, this system is a data aggregator and is not designed with a particular final goal in mind, such as, building a capital market index. The system also does not possess the breadth of data of the instant invention.

The Online Hot Stock market Report Center is a search and web venue for finding stock information that may be of interest to the user. This service does not have a structured database associated with it nor does it provide a comprehensive capital market index structured to guide the user in measuring overall market performance.

The Internet Multicasting Service WWWSite describes, “ . . . building and maintaining public works projects on the Internet.” This Service does not teach assembling information for the purpose of building a capital market index.

The home pages on the world wide web of such large brokerages as J.P. Morgan Chase and Merrill Lynch and the Chicago Mercantile Exchange provide discussions of the firms and their services. None of these imply a comprehensive database of the kind disclosed in the instant invention and none provides a capital market index as a product for managing financial assets.

Scottrade and the affiliated Ameritrade sponsor a website built to help investors inspect the current market and do simple analytical functions such as graphing stock prices. This service provides information limited to equity markets and lacks the comprehensive coverage of the database of the instant invention.

The Stockmaster service combines services from a number of related firms. One such exemplar service provides a stock index with dividends claimed to outperform the Dow Jones and the Standard and Poors averages. This is representative of the provisions of the other included services and, limited to data for stocks only does not reach the comprehensive nature of the database of the instant invention.

There are home pages for libraries and/or departments of numerous university business schools; for example, the Harvard Business School Baker Library or the University of Texas Business School Department of Finance. These generally offer data aggregation and access for their students but none offers the structured database of the instant invention developed for the purpose of calculating the capital market indexes.

No single reference reviewed above presents a complete and comprehensive offering of data across the financial security sphere. None of the references teach selection criteria for securities' data with the object of using said data in calculation of capital markets indexes that represent the broad and complete portfolio enabled by the instant invention and no combination of the above references teaches the comprehensive management of the database of the instant invention.

It is, therefore, an object of the present invention to provide criteria for selecting data for all known publicly available securities to enable use of this data to calculate the indexes disclosed in the '819 application which blend the three major markets of equities, bonds and money markets to form one combined market index representing the blended portfolio. The data sources include:
Reuters
FT Interactive
Standard & Poors
Moody's
Fitch
Global Insight (GI)
Commerce Clearing House (CCH)
Federal Reserve System (FED)
United States Department of the Treasury (DOT)
Federal Deposited Insurance Corporation (FDIC)
(FNMA)
(GNMA)
Freddie Mac
Federal Home Loan (FHL)
Sallie Mae
Farm Credit
New York Stock Exchange (NYSE)
American Stock Exchange (AMEX)
NASDAQ Stock Exchange (NASDAQ)
   It will be recognized by those skilled in the art that the pertinence, accuracy and applicability of said indexes is dependent on the data input. Another object of the present invention is transforming the formats of individual data groups representing selected securities into formats suitable for use in the calculation of the indexes disclosed in the '819 application.

Another object of the present invention is to store, update and maintain the growing database comprising selected data to optimize access and utility in applications to the indexes.

It is a further object of the invention to correct errors in data elements.

It is also an object of the present invention to provide security for the data base including backup storage, restriction of access to qualified users and prevention of corruption computer failure or by external accession by unqualified users.

It is a further object of the invention to provide training in the unique qualities of the database management process and the use of the data in constructing the indexes disclosed in the '819 application.

It is also an object of the present invention to provide stock, bond, and money market indexes to be used in place of the presently used stock, bond and money market indexes.

It is also an object of the present invention to systematically test features and properties of the indexes to indicate changes needed in securities selection criteria and weighting of security classes and market sectors to improve the indexes' accuracy and relevance in depicting relative performance between portfolios, securities, and other indexed asset classes in the marketplace.

Other objects, and the advantages, of the present invention will be made clear to those skilled in the art by the following detailed description of the preferred embodiments thereof.

### SUMMARY OF THE INVENTION

The present invention relates to development and use of a database comprising data for computing capital market indexes which accurately reflect status and changes in the entire securities market. The present invention comprises methods and apparatus for applying criteria for securities selection, acquiring data describing said securities, formatting data for each security, storing and maintaining said data, correcting errors in said data, protecting said data, using said data to calculate capital market indexes. The method is extended to train qualified users recognize the effect of selection criteria for securities in various market sectors (i.e., stocks, bonds, money markets, real estate, commercial real estate, art and other collectibles, etc.) comprising the indexes, to assess and evaluate the weights of various market sectors, to access elements of the database and to utilize the capital market indexes to analyze the economy and to manage investments.

In another aspect, the present invention relates to a method for computing an index comprising the steps of: monitoring market activities in the fixed income and money markets, selecting the best or most relevant price for a chosen group of securities, calculating the index value based upon the change in those prices, and transmitting the calculated index values to the American Stock Exchange (AMEX). The accuracy of the prices of the fixed income securities is ascertained by determining the spread between the fixed income security being examined and an associated Treasury security and adjusting the price of the chosen fixed income security in accordance with changes in price of the fixed income Treasury security, with an override when pricing activity for the fixed income security is observed. The AMEX concurrently is monitoring the equities market and is calculating an index value for a group of equity securities designated in accordance with selection criteria developed to construct the database of the instant invention such as corporate market capitalization, trading volume in round lots of 100, overall liquidity and structure of corporate governance. Following the calculation of these indexes, the indexes are weighted and combined to form the master index, the Capital Markets Index. The weights are determined to reflect the overall proportion of a given market within the capital market; e.g., the proportion of the equity market to the whole.

### BRIEF DESCRIPTION OF THE DRAWINGS

FIG. 1 is an illustration of a preferred embodiment of the general methodology of construction and use of the database of the present invention.

FIG. 2 is an illustration of the subdivision of securities in the securities market into asset classes.

FIG. 3 is a representation of vendor requirements.

### DETAILED DESCRIPTION OF INVENTION

In a preferred embodiment, the method of the present invention provides the functions of data identification, acquisition, standardizing data, up-dating, verification, correction of omissions and errors, formatting, weighting data elements, storage, protection and preparation for use in the capital market indexes disclosed in the '819 application. The database disclosed in the preferred embodiment of the instant invention provides the input for the construction of three major combined indexes reflecting the history, current behavior and trends of the financial securities market. The Capital Market Index (CPMKT) is a daily index that represents the change in total return for all securities in all capital markets. The Capital Market Investment Grade Index (CPMKTIG) represents the change in total return for the traditional investment grade capital market securities. The Capital Market Real Time Index (CPMKTS) is an index compiled and computed continuously (updates every fifteen seconds in a preferred embodiment) during market hours and represents the change in total return for the traditional investment grade capital market securities. Here, “traditional” reflects those securities comprising most of both the capital securities markets liquidity and held or traded securities.

The CPMKT index is the broadest and most complete measure of the capital market. It is calculated using data describing every single available individual capital market security. The universe of securities indicated by asset class is discussed below. In addition to the traditional investment grade products presented in the CPMKTIG index and in databases such as those described in the Background of the Invention, above, the CPMKT includes newer or non-traditional capital market securities. The CPMKT is designed to accommodate additional data so that as the financial and investing community creates new securities products, these products will be incorporated into the CPMKT index. Examples of new products introduced over the last twenty-six years include adjustable mortgages and asset backed securities. Examples of products that are not considered investment grade products include designated securities such as Pink Sheet stocks and High Yield Corporate Bonds.

The CPMKTIG index is the most consistent measure of the capital market. It is calculated using data representing each security in the investment grade subdivisions of the capital securities market. These include all of the money market instruments of Bankers Acceptances, Commercial Paper, Short Term large Certificates of Deposit and Agency Discount Notes, as well as Common Stock from the equities market. In the fixed income markets the CPMKTIG index includes all U.S. Treasury issues, short and long term Federal Agency bonds, short and long term mortgage-backed securities and any investment grade corporate bond. Taking only the traditional investment grade products provides a consistent measure of the capital markets since the types of constituent securities do not change over time and individual assets within these types change very slowly. Proper asset weighting for the entities included in the CPMKTS can not be computed without calculating the asset weightings from the entities included in the CPMKTIG index. Equally important, the CPMKTIG is the only tool capable of validating the methods and results of the real-time CPMKTS index. This is because the data representing the constituent securities in the CPMKTS are chosen from among the securities of the CPMKTIG. It would be impossible to verify the accuracy of the CPMKTS without the CPMKTIG because no other single product tracks the complete investment grade capital markets.

Therefore, CPMKTS index is a real-time complement to the CPMKTIG. In a presently preferred embodiment, it comprises approximately two thousand, four hundred (2400) constituent members, which are selected from among the assets included in the CPMKTIG. In the preferred embodiment, the members in the CPMKTIG are selected to represent all of the diverse elements of the CPMKTIG. The component indexes of the CPMKTS are weighted according to the weightings of the CPMKTIG. The CPMKTS is the only real-time measure of the majority of entities in the U.S. capital markets.

The database supporting calculation of these and subsidiary indexes as discussed below is unique because of its comprehensive inclusion of all securities in the capital markets, the selection processes which determine the database components, the application of methods to correct omissions and errors to enhance the accuracy of the data, standardize terminology and the volume of data stored and managed.

In the preferred embodiment described herein, the computing needs to support the database of the instant invention include storage capacity of approximately 2.7 terabytes for the database and the ability to manage approximately 10 gigabytes of data in the daily flow of updates. The data is compressed and normalized using standard relational data base practices. The data is acquired through secure connections across the internet to vendor environments and by use of dedicated communication circuits to vendor environments as is well known in the art. The data once acquired, corrected, and standardized, formatted and organized is output through the same modalities. A more complete discussion of corrections is provided below.

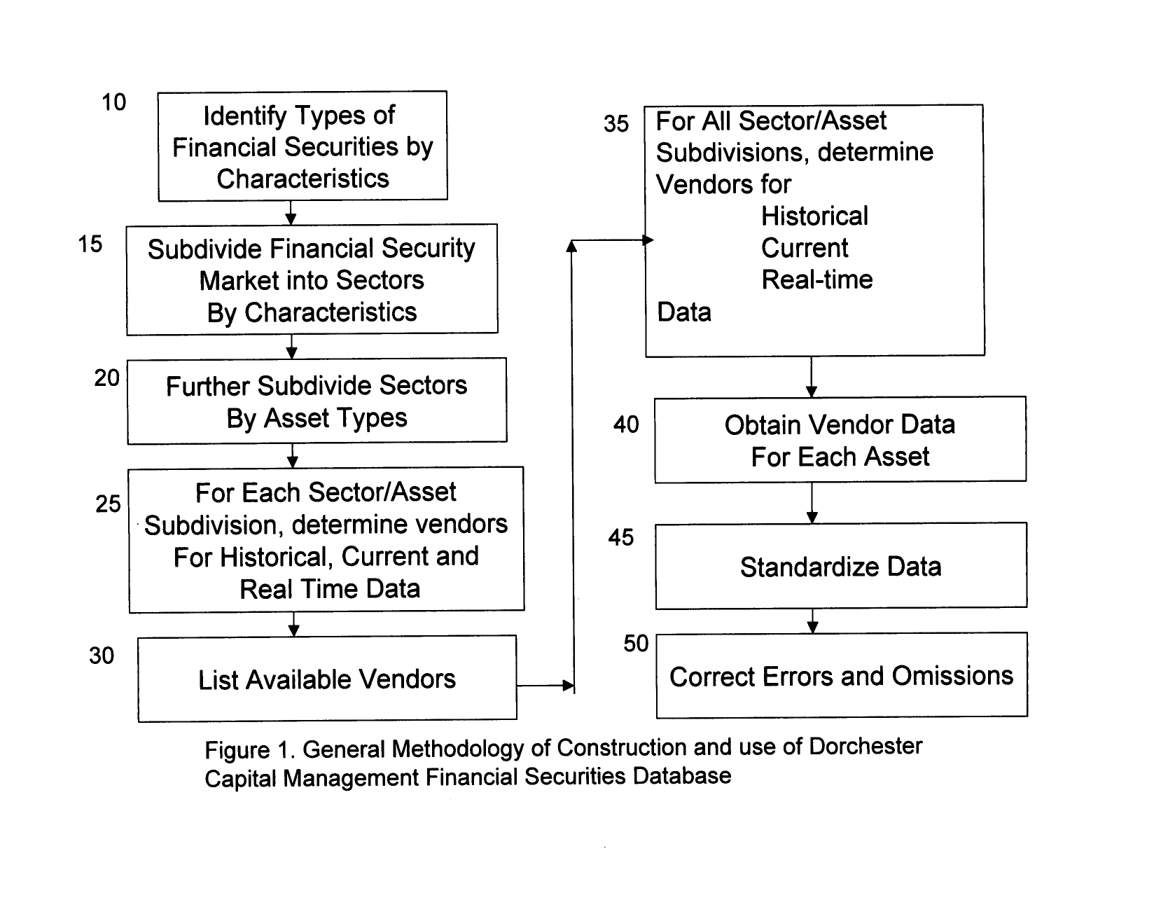

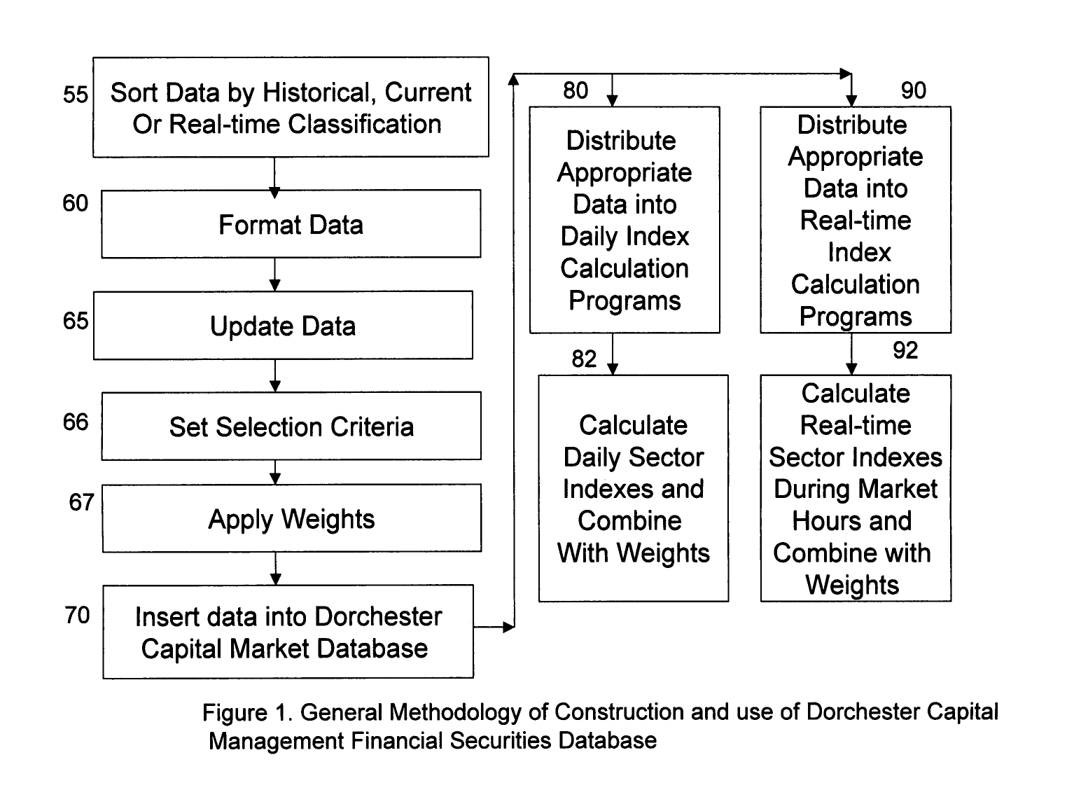

Referring first to FIG. 1, an overview of a preferred embodiment of the method of the present invention is illustrated. The first step (indicated generally by the numeral 10) in the preferred method illustrated in FIG. 1 is to identify the types of financial securities by characteristics. Next, the method subdivides the securities market into sectors based on said characteristics in step 15. This is followed by further subdividing said sectors into classes of asset types in step 20. Step 25 shows continuation of the process as data vendors are determined for each Sector/Asset subdivision. The process continues in step 30 with listing available vendors. In step 35, individual vendors for historical, current and real-time data are determined. Vendor data for each type of asset is obtained in step 40. The data is standardized in step 45. This is required because different vendors use different terminology to describe the same type of asset. Data for each asset is stored using a standardized, common terminology which is developed as part of the method described in the preferred embodiment of the instant invention. The method of the instant invention maps terminology of the various vendors into a standard terminology used for describing the assets used in the capital indexes. Omissions in the data are rectified and the data is corrected in step 50. In step 55, the data is sorted into historical, current or real-time categories. The data is formatted in step 60. This is necessary because different vendors use different digital formats for their individual data. The method of the instant invention converts each data element into a common format for use in calculating the indexes. Step 65 indicates updating the data. Updates are performed at different time periods for different asset types. As indicated above, current data is updated at the end of each market day. Real-time data is updated every fifteen (15) seconds during a market day as performed in the preferred embodiment. Historical data is updated at different frequencies depending on the asset. This updating may occur, daily weekly, monthly, quarterly or yearly. Step 70 describes the insertion of the data into the Capital Markets Database. Step 80 describes the distribution of daily data into daily index calculation programs. Step 82 describes the calculation of daily indexes and combination of the various indexes with appropriate weights. Step 90 similarly describes the distribution of real-time data into real-time index calculations. Step 90 describes the calculation of real-time indexes and combination with appropriate weights. Steps 80, 82, 90 and 92 mark the beginning of use of the database constructed with the instant invention in the calculations taught in the 819 application.

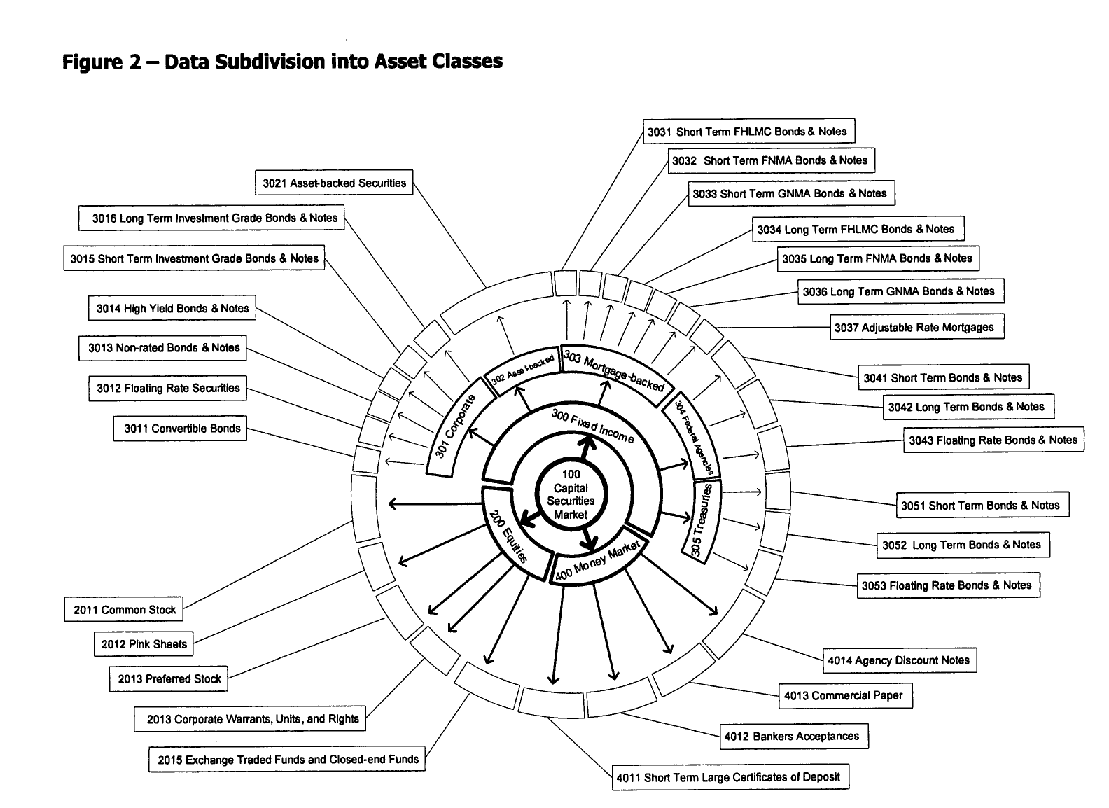

The first step in FIG. 2 labeled 100 indicates focus on the capital securities market. This market is divided into three sectors, Equities 200, Fixed Income Securities 300, and Money Market Instruments 400. The Equities category 200 is further subdivided into five (5) asset classes: Common Stock 2011, Pink Sheet Stock 2012, Preferred Stock 2013, Corporate Warrants, Units and Rights 2014 and Exchange Traded Funds and Closed-end Funds 2015.

Fixed Income Securities 300 is further subdivided into five sub-sectors: Corporate Bonds and Notes 301; Asset-backed Bonds and Notes 302; Mortgage-backed Bonds and Notes 303; Federal Agency Bonds and Notes 304; and U.S. Treasury Bonds and Notes 305.

The next subdivision is into asset classes. Equities 200 is subdivided into: Common Stock 2011; Stock sold through the Pink Sheets 2012; Preferred Stock 2013; Corporate Warrants, Units, and Rights; 2014; and Exchange Traded Funds and Closed-end Funds 2015.

Each of the five (5) sectors is divided into between one (1) and seven (7) different asset types combinations for a total of twenty (20) sector/asset type combinations. Corporate Bonds and Notes 301 is further subdivided into: Convertible Bonds 3011; Floating Rate Securities 3012; Non-rated Bonds and Notes 3013; High Yield Bonds and Notes 3014; Short Term Investment Grade Bonds and Notes 3015; and Long Term Investment Grade Bonds and Notes 3016. Asset backed securities 302 is its own asset class. The Mortgage Backed Securities sector is further subdivided into asset classes Short Term Federal Home Loan Mortgage Corporation (FHLMC) Bonds and Notes 3031, Short Term Federal National Mortgage Association (FNMA) Bonds and Notes 3032, Short Term Government National Mortgage Association (GNMA) Bonds and Notes 3033, Long Term FHLMC Bonds and Notes 3034, Long Term FNMA Bonds and Notes 3035, Long Term GNMA Bonds and Notes 3036, and Adjustable Rate Mortgages 3037. Of the twenty (20) possible combinations, a subset is chosen based on coupon types or values that make these securities highly liquid. These become the basis for the eight (8) real-time fixed income indexes. In these eight (8) groups, another subset of the issues that are not callable, putable or sinkers are eligible for selection as proxies for their subdivision. Callable Bonds, also know as Optional Principal Redemption Bonds are bonds with multiple, discrete call dates upon which the bond can be redeemed in whole or in part. Putable bonds are subject to repurchase by the Federal Home Loan (FHL) Banks at the request of the bondholder before the final stated maturity date. The ability to exercise the put option may depend upon certain market conditions or other criteria specified in the Offering Notice. If the bondholder wishes to exercise the put option, proper notification must be delivered to the Office of Finance. Generally, putable bonds are redeemable on interest payment dates after an initial lockout period. Sinker bonds are bonds with long-term coupons but short maturity, usually a home financing bond.

Federal Agency Bonds and Notes 304 is further subdivided into asset classes Short Term Bonds and Notes 3041, Long Term Bonds and Notes 3042, and Floating Rate Bonds and Notes 3043. United States Treasury Bonds and Notes 305 is further divided into asset classes Short Term Bonds and Notes 3051, Long Term Bonds and Notes 3052, and Floating Rate Bonds and Notes 3053.

The Money Market 400 is divided into asset classes Bankers' Acceptances 4011, Short Term Large Certificates of Deposit 4012, Commercial Paper 4013, and Agency Discount Notes 4014.

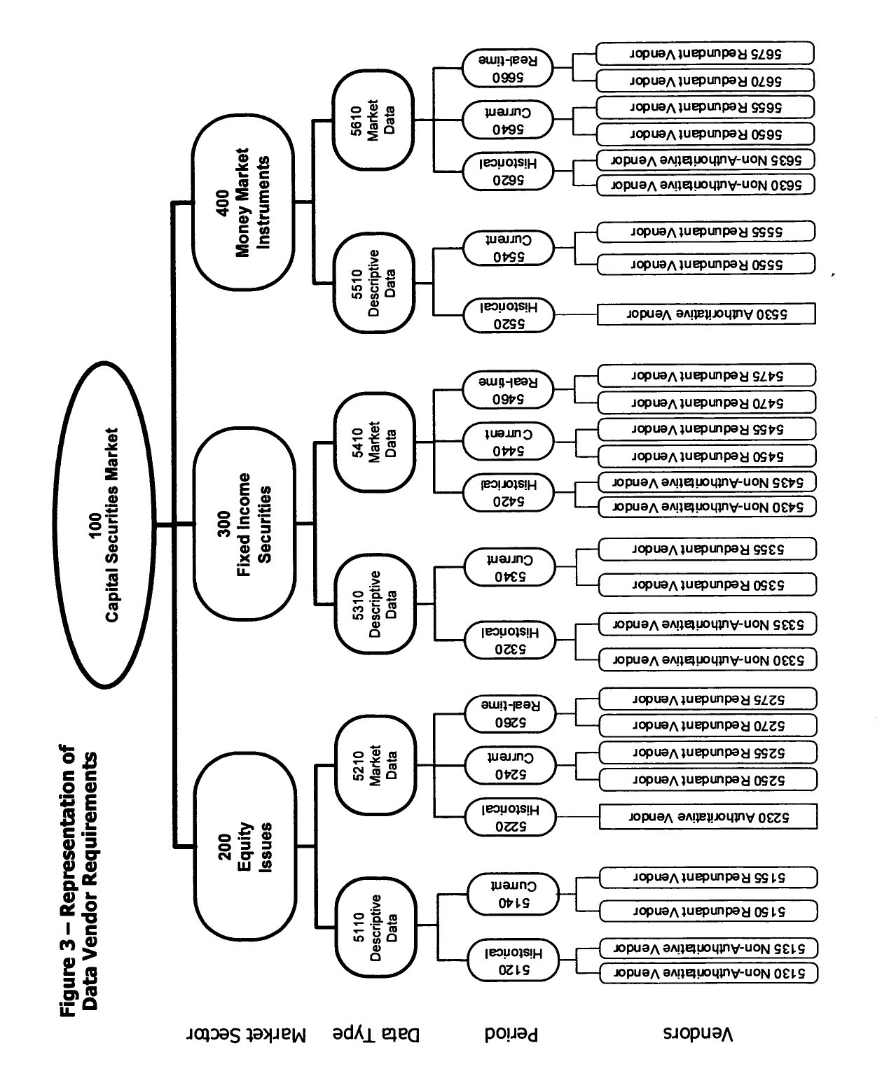

FIG. 3 depicts the representation of data vendor requirements. The Capital Securities Market 100 is subdivided as in FIG. 2 into Equities 200, Fixed Income Securities 300 and the Money Market 400. The diagram describes the partitions of data into descriptive and market data and further partitions of historical, current and real time data. Lastly the diagram shows the types of vendors providing each kind of data. Specifically, Equities 200 requires descriptive data 5110 and market data 5210. Descriptive data 5110 is comprised of historical data 5120 including names of companies, identifiers for specific securities issues, issue date, maturity date and description of the security as well as current data 5140 including day to day revisions of the historical items or new securities as they emerge.

Historical data 5120 is provided by non-authoritative vendors 5130 and 5135. Here the two vendors 5130 and 5135 indicate a plurality of possible vendors. Current Equities descriptive data 5140 is provided by redundant vendors 5150 and 5155. Again, 5150 and 5155 represent a plurality of potential vendors. These vendors are termed redundant because, in current embodiment of the invention, the database should not be compromised if a single vendor fails to provide needed information.

Equities market data 5210 consists of historical data 5220 (including pricing history, historical ratings history, and adjustment to equity shares outstanding), current data (day to day changes to market data) 5240 and real-time data (pricing information) 5260. Historical data 5220 is provided by an authoritative vendor 5230 which is a single vendor which is recognized as consistently accurate in purveying data. Current data 5240 is provided by redundant vendors 5250 and 5255. Real-time data 5260 is provided by redundant vendors 5270 and 5275. The same exact approach applies to the fixed income and money markets as depicted in FIG. 3 except that the elements are numbered to correspond with the separate entities.

The capital market indexes require detailed information in a digital format regarding all publicly traded securities including the asset classes which have been defined above stemming from equity securities, fixed income securities and money market instruments. For each such security, the indexes require detailed descriptive issuer information as well as accurate market data. The detailed descriptive information will include the issuer, the type of data being accessed, the standard industry code (SIC) for the security and the unique, nine-character number defined by the Committee on Uniform Securities Identification Procedures for each class of a security approved for trading in the United States (CUSIP). Market data may include the following, as applicable to a specific security: pricing, factors, debt ratings, current debt outstanding, coupon rates, current shares outstanding, and all corporate actions.

Corrections to Equity CUSIP Changes

The CUSIP is a unique identifier used on all regulated securities. It is nine characters in length. The first six characters are specific to the issuing organization. The seventh and eight characters are specific to the security itself and the ninth character is a check-sum character determined by the first eight.

Various corporate actions such as mergers, acquisitions, corporate name changes will also result in a change to the cusip. If one uses two data vendors to supply equity information and cusip changes are not implemented consistently between the two vendors, then it is possible to have on a given day to have two securities with different cusips that are in fact the same security. The effect on an index calculation is that the market value of a security would be double counted until the cusips were correctly synchronized.

The most direct method for correcting aberrant cusip changes is to have a schedule of changes. That schedule would include the previous cusip, the current cusip and the date on which the change was implemented. The combined data source is then examined in the two following ways:

1. Look for records with the current cusip before the change date.

2. Look for records with the previous cusip after the change data. In both cases, such the incorrect records are marked as inactive and are therefore removed from any subdivisions, index selections and index calculations.

Though the cusips are different, other characteristics of the security can be compared to discover duplication. Specifically the daily price, volume and shares outstanding for the security will be identical or will differ by a very small amounts.

In this case, the record set is examined each day searching for two securities with the following characteristics
1. Different cusips.
2. Difference in price that is less than 0.1%
3. Difference in volume that is less than 0.1%
4. Difference in shares outstanding that is less than 10 shares.
   Matches to these criteria are flagged and then reviewed. In most cases, the issuer description information matches closely enough that it can be verified that the two securities are actually the same issue. This can be confirmed with other data vendors such as CCH, or with the SEC's EDGAR site, or with S&P's www.cusip.com site, or even with a search engine. As with the first method, any incorrect records are marked as inactive and are therefore removed from any subdivisions, index selections and index calculations.
   Corrections to Equity Splits

Companies, for various reasons, will split or reverse split their common stock equity shares. A stock split divides the shares into a larger number, adjusting the price per share by the reciprocal ratio, with no change in the total value of the company. For example a company with 100,000 shares at a price of $100 per share has a market capitalization of $10,000,000. The company performs a share 2 for 1 share split, increasing the number of shares to 200,000 and reducing the price per share to $50. The total market capitalization of the company is still $10,000,000, but the number of shares has doubled. The date on which the share split equity event occurs is called the ex date. If the date for the price change and the date for the change in the shares outstanding do not match, or if either does not match the ex date, then the calculation of the market capitalization will be wrong. The most reliable data for the equity securities is the pricing data, with the ex date and shares outstanding data being less reliable. Starting with an ex date, and a split ratio, a program would go to as many as 45 days before and 45 days after the ex date looking for a day to day price change to match the split ratio. When a matching price change is detected, the ex date is adjusted, as is the shares outstanding, to match the revised split event data.

Corrections to Errors in a Series of Values

Much of the market data follows predictable patterns. For example, prices for fixed income securities tend to change by a small amount each day. A typical series looks like this: 99.929, 99.939, 99.939, 99.952, 99.955, 99.925, 99.927. However, if the series were to look more like this: 99.929, 99.939, 99.939, 99.952, 2.000, 99.925, 99.927, then the fifth element, 2.000, is incorrect. This approach applies most directly to fixed income pricing and mortgage-backed security's factors, which have the most consistent pattern. It also applies to prices for equity securities, though they do have a greater volatility.

Several characteristics go into calculating the market value of a security and there are two approaches to testing each of these characteristics in the equation for a securities market value. The most exhaustive is to devise individual tests for each characteristic and then apply those tests against the securities data.

The second is to calculate the total return percentage across a period and investigate any returns whose absolute value is greater than 20%. The advantage of the second method is that it tests several characteristics of a security with a single computation. The securities are investigated individually and errors to the price or factor are corrected.

Corrections to Securities Descriptive Characteristics

Securities with an incorrect asset type or country code will not be placed in the correct subdivision, which will eventually skew the index values. With the country code, in many cases the vendors simply do not report a country code, or incorrectly report the country code of a corporation. The following rules are applied to discover and then to correct the errors:
1. The cusip for United States based companies always starts with a number in the first position.
2. Companies that are not based in the United States, but who have securities that trade in the United States will have an alphabetic character in the first position of their cusip.
3. Any company whose company name includes Corp or Inc is based in the United States.
4. Any company whose issue description includes the word ADR is not based in the United States.
5. Any company whose name includes PLC is not based in the United States.
   Suspect companies are investigated using resources such as the SEC's EDGAR database (www.sec.gov), Standard & Poor's CUSIP resources (www.cusip.com), the company's own web site, or popular search engines.

Many funds were incorrectly coded by the securities data vendors as common stock (asset type 4000) instead of as an open-end find (asset type 4040). These issues were all coded as asset type 4000, yet have the words “mist” or “fund” in their issue description field. Also common is that they would end with the two characters “FD”, indicating a fund. Finally, several companies release finds all starting with the company name.

Corrections to Fixed Income Prices

With two sources for fixed income security data, it is possible that daily closing prices do not match. One source was chosen as the preferred source for pricing data. When gaps existed in the pricing information from the preferred source, and the secondary source had updated pricing, a current price would be derived from the secondary source. The price is derived by adjusting the last good price of the primary source by the percentage change in price of the secondary source. This approach continues until the primary source again supplies a price for the security.

Historical information dating from 1979 is required, as well as on-going information, such as prices and other market activity. All of these data elements must be updated on a regular basis consistent with each data element's change in the market.

Data sources that are completely authoritative (such as the US Treasury Department's Public Debt information) must be used. In the instances where no sole authority is available, multiple, redundant sources providing the same kind of data must be employed and checked against each other to ensure the most accurate description of the market possible.

In creating and calculating Capital Market Indexes, two fundamental approaches are available as illustrated in FIG. 1. These approaches are differentiated by the period in which they are reported and the frequency in which they are updated. These approaches further define data attributes used in the indexes. First, daily indexes 80 and 82 can be constructed and calculated. Secondly, “real-time” indexes can be constructed and calculated 90 and 92 during market hours, to be updated at predetermined intervals as market activity is reported.

A daily index is updated every market day and has two properties: (1) it provides a more complete and comprehensive description of the market since each of the 1.1 million active securities can be acquired and processed within a twenty-four hour period; and (2) it is more suitable for longer term trending and analysis since it incorporates daily closing data, the most commonly employed statistical measure.

A “real-time” index is constructed and calculated during market hours and is updated as market activity is reported. A real-time index has three properties: (1) it is a precise measure of security performance during market hours, reflecting current market activity; (2) the limits of digital storage technology impose restrictions on the volume of data which can be accessed and processed, thus only a subset of the 1.1 million active securities can be tracked during market hours; and (3) a real-time index enables creation of financial products that can be actively traded and tracked during market hours.

The general criteria for selecting subdivisions to be incorporated in a real-time index are that it must: (1) be a “traditional investment grade” security as understood by the financial community; (2) have a sufficiently liquid market, generating enough activity to be reflected in an index updated every fifteen (15) seconds during market hours; and (3) not be a derivative security product, but an original issue based upon the value or credit of a single entity.

Money Market Indexes Comparison

Due to the limited number of securities in this sector and the fact that updates occur mostly on a daily basis, the real-time representation of the daily Money Market Instrument Indexes is identical to the real-time. Index composition and calculation is identical.

| Money Market Instrument Subdivision | Corresponding Real-time Index |
|---|---|
| US Bankers Acceptances | US Bankers Acceptances |
| US Short Term Large Certificates of | US Short Term Large |
| Deposit | Certificates of Deposit |
| US Commercial Paper | US Commercial Paper |
| US Agency Discount Notes | US Agency Discount Notes |

Equity Securities Indexes Comparison

The only portion of the equity markets that is considered investment grade, has suitable liquidity, and is not a derivative product is the market for common stock.

| Equity Security Subdivision | Corresponding Real-time Index |
|---|---|
| Common Stock (100 | 2000 largest companies based upon |
| share round lots) | Common Stock market capitalization |
| Pink Sheets | No corresponding real-time index because |
| | not considered investment grade securities |
| Preferred Stock | No corresponding real-time index because |
| | of limited market activity |
| Warrants, Units, and Rights | No corresponding real-time index because |
| | of limited market activity |
| Exchange Traded Funds | No corresponding real-time index because |
| and Closed-end Funds | derivative security products. |

Differences between Common Stock Subdivision and Real-time Common Stock Index

Only the 2,000 largest companies by market capitalization are selected from the subdivision of common stock companies. For companies with multiple common stock issues, such as class A and class B stock, each of the common stock issues is combined together to determine the company's total market capitalization. Companies that are not a corporation, such as a Limited Liability Corporation, are not included in the real-time index. Companies whose common stock does not trade in round lots of 100 are not included in the real-time index.

Fixed Income Securities Indexes Comparison

Of the twenty fixed income security subdivisions, ten are represented by the four liquidity and four bond real-time indexes. Note that all have a one to one correspondence, except for the three long term mortgage-backed securities subdivisions. These are represented in the single real-time mortgage-backed index.

| Fixed Income Security Subdivision | Corresponding Real-time Index |
|---|---|
| US Treasury Bills | US Treasury Bills Index |
| Short Term Treasury Bonds & Notes | Short Term Treasury Bonds & Notes Index |
| Long Term Treasury Bonds & Notes | Long Term Treasury Bonds & Notes Index |
| Short Term Federal Agency Bonds & | Short Term Federal Agency Bonds & |
| Notes | Notes Index |
| Long Term Federal Agency Bonds & | Long Term Federal Agency Bonds & |
| Notes | Notes Index |
| Floating Rate Federal Agency Securities | No corresponding real-time index because |
| | illiquid. |
| Short Term Federal Home Loan Mortgage | No corresponding real-time index |
| Corporation Bonds & Notes | |
| Short Term Federal National Mortgage | No corresponding real-time index |
| Association Bonds & Notes | |
| Short Term Government National | No corresponding real-time index |
| Mortgage Association Bonds & Notes | |
| Long Term Federal Home Loan Mortgage | Represented in the real-time mortgage |
| Corporation Bonds & Notes | index. |
| Long Term Federal National Mortgage | Represented in the real-time mortgage |
| Association Bonds & Notes | index. |
| Long Term Government National | Represented in the real-time mortgage |
| Mortgage Association Bonds & Notes | index. |
| Adjustable Mortgage Securities | No corresponding real-time index |
| Asset-backed Securities | No corresponding real-time index |
| Short Term Corporate Investment Grade | Short Term Corporate Investment Grade |
| Bonds & Notes | Bonds & Notes Index |
| Long Term Corporate Investment Grade | Long Term Corporate Investment Grade |
| Bonds & Notes | Bonds & Notes Index |
| Corporate Convertible Corporate Bonds & | No corresponding real-time index |
| Notes | |
| Corporate High Yield Corporate Bonds & | No corresponding real-time index |
| Notes | |
| Corporate Non-rated Corporate Bonds & | No corresponding real-time index |
| Notes | |
| Corporate Floating Corporate Rate | No corresponding real-time index |
| Securities | |

Differences between the US Treasury Bills Subdivision and Real-time US Treasury Bills Index

The index is identical to the subdivision.

Differences between the US Treasury Short Term Bonds & Notes Subdivision and Real-time US Treasury Short Term Bonds & Notes Index

Only securities with an asset type such as a Bond/Note, are used. The securities selected as proxies cannot be callable, putable or sinkers as those terms are defined above.

Differences between the US Treasury Long Term Bonds & Notes Subdivision and Real-time US Treasury Long Term Bonds & Notes Index

Only securities with an asset type of Bond/Note, are used. The securities selected as proxies cannot be callable, putable or sinkers.

Differences between the Federal Agency Short Term Bonds & Notes Subdivision and Real-time Federal Agency Short Term Bonds & Notes Index

The securities must be issued by one of the following five agencies:
Federal National Mortgage Association (FNMA: Fannie Mae)
Federal Home Loan Mortgage Corporation (FHLMC: Freddie Mac)
Federal Home Loan Banks (FHLB)
Federal Farm Credit Banks (FFCB)
Student Loan Marketing Association (SLMA: Sallie Mae)
   The securities selected as proxies cannot be callable, putable or sinkers.
   Differences between the Federal Agency Long Term Bonds & Notes Subdivision and Real-time Federal Agency Long Term Bonds & Notes Index

The securities must be issued by one of the following five agencies:
FNMA
FHLMC
FHLB
FFCB
SLM
   The securities selected as proxies cannot be callable, putable or sinkers.
   Differences between the Long Term Mortgage-backed Securities Subdivision and the Real-time Mortgage-backed Securities Index

The securities must be issued by one of the following programs:
FHGOLD-15 YR
FHGOLD-30 YR
FHGOLD-5 YR Balloon
FHGOLD-7 YR Balloon
FNMA-15 YR
FNMA-30 YR
FNMA-7 YR Balloon
GNMA-15 YR
GNMA-30 YR
   The coupon must be a multiple of 0.5. The coupon must be within a periodically adjusted set of bounds, such as from 4.5 to 9.0. The securities selected as proxies cannot be callable, putable or sinkers.
   Differences between the Short Term Corporate Investment Grade Bonds & Notes Subdivision and the Real-time Short Term Corporate Investment Grade Bonds & Notes Index

The securities must be one of the following asset types:
Bond/Note
Loan/Note
Equipment/Lease
   The securities must have one of the following coupon types:
Fixed coupon
Fixed coupon—Interest-at-Maturity
Discount
Zero coupon
   The securities selected as proxies cannot be callable, putable or sinkers. The securities selected as proxies must be from a company with an equity common stock issue in the Real-time Common Stock Index.
   Differences between the Long Term Corporate Investment Grade Bonds & Notes Subdivision and the Real-time Long Term Corporate Investment Grade Bonds & Notes Index

The securities must be one of the following asset types:
Bond/Note
Loan/Note
Equipment/Lease
   The securities must have one of the following coupon types:
Fixed coupon
Fixed coupon—Interest-at-Maturity
Discount
Zero coupon
   The securities selected as proxies cannot be callable, putable or sinkers. The securities selected as proxies must be from a company with an equity common stock issue in the Real-time Common Stock Index.

There are three levels to the real-time indexes and three corresponding partitions in the database which is the preferred embodiment of the instant invention. The single summary real-time index is CPMKTS. It is composed of three market indexes equity markets (CPMKTE), liquidity markets (CPMKTL), and bond markets (CPMKTB). Each of the market indexes is calculated based upon one or more security indexes.

These indexes are described in the following table:

| TICKER | MARKET | SECURITY | |
|---|---|---|---|
| INDEX | INDEXES | INDEXES | DESCRIPTION |
| CPMKTS | CPMKTE | | Real-Time Equities Index |
| | | CPMKTE | Selection common stock for the 2,000 |
| | | | largest US companies based upon total market |
| | | | capitalization |
| | CPMKTL | | Real-Time Liquidity Index |
| | | CPMKTLCBO | Selection of investment grade corporate |
| | | | bonds with a maturity less than one year of |
| | | | US companies included in the CPMKTSE |
| | | | index |
| | | CPMKTLBI | Selection of US Treasury Bills |
| | | CPMKTLTBO | Selection of US Treasury bonds and notes |
| | | | with a maturity less than one year |
| | | CPMKTLAG | Selection of US Federal Agency securities |
| | | | with maturity less than one year |
| | | CPMKTLCD | Listing of certificate of deposit securities |
| | | CPMKTLCP | Listing of commercial paper securities |
| | | CPMKTLBA | Listing of banker's acceptance securities |
| | CPMKTB | | Real-Time Fixed Income Index |
| | | CPMKTBCBO | Selection of investment grade corporate |
| | | | bonds with a maturity of one year or greater |
| | | | of US companies included in the |
| | | | CPMKTSE index |
| | | CPMKTBMG | Selection of mortgage backed securities |
| | | | with a maturity of one year or greater |
| | | CPMKTBTBO | Selection of US Treasury bonds and notes |
| | | | with a maturity of one year or greater |
| | | CPMKTBAG | Selection of US Federal Agency securities |
| | | | with a maturity of one year or greater |

Data Selection for the Real-Time Equity Index

There is only one component selected for the CPMKTE real-time equity index, denoted the CPMKTSE index. Data for this index membership is determined quarterly. Beginning with the equities from the overnight CPMKTEQUS Index, this index selects those companies that are publicly traded in round lots of one hundred (100) shares and of these, the top 2,000 companies based upon total market capitalization are selected for inclusion in the database for use in the CPMKTSE index. For companies with two or more common stock issues, the company's total market capitalization is the sum of the market capitalization for each common stock issue.

The members are selected based upon market capitalization of the fourth market day before the start of the quarter. For example, the CPMKTSE for the fourth quarter of 2005 (October through December) was determined based upon the market capitalization computed from the outstanding shares and closing share prices from Sep. 27, 2005.

For companies with multiple stock issues, the issue with the highest daily volume is the representative issue. The outstanding share count for the highest volume issue is then adjusted so that this single issue represents the total market capitalization of the company. This revised outstanding share count is the share count used to calculate the value of the company within the index for the following quarter.

Examples of Companies not selected include: limited partnerships, illiquid companies such as Berkshire Hathaway, and non-American companies such as Accenture which is based in Bermuda. Examples of companies selected for the database include Schlumberger and Puerto Rican Companies.

Data Selection for the Real-time Liquidity Markets Index

The Real-time Liquidity Markets Index (CPMKTL) is composed of fixed income securities with a maturity less than one year and Money Market securities. Due to the short duration, the membership of the real-time security indexes for the CPMKTL is determined monthly, on the fourth business day before the beginning of the month.

Data Selection for Short Term US Corporate Bonds (CPMKTLCBO)

The CPMKTLCBO is a selection of investment grade US corporate bonds with a maturity less than one year. The selection is broken into two maturity classes and two ratings.

| Maturity Classes | Ratings |
|---|---|
| 0 to 6 months | Tier 1 & 2 |
| 6 to 12 months | Tier 3 & 4 |

For each maturity class and rating combination, the two securities with the most recent issue date are selected. The market value weight assigned to each issue is one half the total market value for all of the issues in the maturity-rating combination. If there is only one issue for a maturity-rating combination, then the market value weight for that issue is the sum of the market values for all of the issues in that combination after choosing diverse issues from all the proxy issues that satisfy the criteria for that combination.
Data Selection for US Treasury Bills (CPMKTLTBI)

The CPMKTLTBI is a selection of treasury bills. The CPMKTLTBI is broken into four maturity classes. The selection of representative securities in the CPMKTLTBI occurs monthly, on the fourth business day before the beginning of the month.

Maturity Classes

| | |
|---|---|
| 0 to 3 | months |
| 3 to 6 | months |
| 6 to 9 | months |
| 9 to 12 | months |

Two issues are selected from each of the four maturity classes. The first issue is the one with the greatest maturity date within the maturity class. The second one is the one is the middle maturity date. In the event that there is an even number of securities, choose the one with the lesser value.

The market value weight of the middle issues is the sum of the market values of the issues with a maturity less than or equal to itself. This includes the middle issue. The sum of the market values of the remaining issues, including the final issue, is used to determine the weight of the other selected issue.

The following table serves as an example. It lists all of the Treasury Bills with a maturity between 0 and 3 months on Sep. 27, 2005. They are sorted in order of maturity date from least to greatest. There are 13 issues and the seventh, cusip 912795VZ1, is selected as the middle issue. Its weight will be calculated based upon the sum of the market values for the first seven issues, $363,841,827,687. The second selection is the last issue, cusip 912795WF4. Its weight will be calculated based upon the sum of the market value for the final 6 issues, $244,279,292,904.

Treasury Bills with Maturity 0 to 3 Months from Sep. 27, 2005

| CUSIP | Maturity Date | Price | Face | Market Value | Weight |
|---|---|---|---|---|---|
| 912795VT5 | 20050929 | 99.991 | 46,638,793,000 | 46,634,595,509 | |
| 912795VU2 | 20051006 | 99.936 | 59,284,658,000 | 59,246,715,819 | |
| 912795VV0 | 20051013 | 99.88 | 57,074,002,000 | 57,005,513,198 | |
| 912795VW8 | 20051020 | 99.813 | 56,740,304,000 | 56,634,199,632 | |
| 912795VX6 | 20051027 | 99.753 | 58,008,905,000 | 57,865,623,005 | |
| 912795VY4 | 20051103 | 99.696 | 43,413,877,000 | 43,281,898,814 | |
| 912795VZ1 | 20051110 | 99.628 | 43,334,486.000 | 43,173,281,712 | 363,841,827,687 |
| 912795WA5 | 20051117 | 99.555 | 44,082,416,000 | 43,886,249,249 | |
| 912795WB3 | 20051125 | 99.48 | 46,191,030,000 | 45,950,836,644 | |
| 912795WC1 | 20051201 | 99.429 | 20,995,530,000 | 20,875,645,524 | |
| 912795WD9 | 20051208 | 99.36 | 45,488,531,000 | 45,197,404,402 | |
| 912795WE7 | 20051215 | 99.291 | 45,311,188,000 | 44,989,931,677 | |
| 912795WF4 | 20051222 | 99.213 | 43,723,328,000 | 43,379,225,409 | 244,279,292,904 |

Data Selection for Short Term US Treasury Bonds/Notes (CPMKTLTBO)

The CPMKTLTBO is a selection of treasury bonds and notes. The CPMKTLTBO is broken into four maturity classes:

Maturity Classes
0 to 3 months
3 to 6 months
6 to 9 months
9 to 12 months

For each of these classes, two issues are selected, the two issues with the greatest value for the issue date. Their market value weights are then assigned with half of the total market value for the maturity class to each of the two issues.

In the example below, the two issues with the greatest issue date are 91282BN9 and 91282BS8. The total market value for the maturity class is $139,373,027,472. Each of these two issues would use half of that, $69,686,513,736, to determine their weight.

Treasury Bonds/Notes with Maturity 0 to 3 Months from Sep. 27, 2005

| CUSIP | Maturity Date | Issue Date | Coupon | Price | Face | Market Value |
|---|---|---|---|---|---|---|
| 912827V82 | 20051115 | 19951124 | 5.875 | 100.309 | 15,209,920,000 | 15,256,918,653 |
| 9128276N7 | 20051115 | 20001115 | 5.75 | 100.297 | 28,062,797,000 | 28,146,143,507 |
| 912828BL3 | 20050930 | 20030930 | 1.625 | 99.988 | 31,538,969,000 | 31,535,184,324 |
| 912828BN9 | 20051031 | 20031031 | 1.625 | 99.844 | 32,368,420,000 | 32,317,925,265 |
| 912828BS8 | 20051130 | 20031201 | 1.875 | 99.73 | 32,203,806,000 | 32,116,855,724 |

Data Selection for Short Term US Federal Agency Bonds (CPMKTLA)

The CPMKTLA is a selection of US Federal Agency issues. The CPMKTLA is broken into four maturity classes, two asset types, and five agency categories:

| Maturity Classes | Asset Types | Agency Categories |
|---|---|---|
| 0 to 3 months | 1000: Bond/ | FNMA: Federal National Mortgage |
| | Notes | Association (Fannie Mae) |
| 3 to 6 months | 5040: Discount | FHLMC: Federal Home Loan |
| | Notes | Mortgage Corporation (Freddie |
| | | Mac) |
| 6 to 9 months | | FHLB: Federal Home Loan Banks |
| 9 to 12 months | | FFCB: Federal Farm Credit Banks |
| | | SLM: Student Loan Marketing |
| | | Association (Sallie Mae) |

The 5040 asset type, Discount Notes, only applies to short term issues. Only the five main agencies are included. The “Other” category is excluded.

For the short term issues, there are two selection approaches. First, for the agencies with the Discount Notes, select one security, the one with the most recent issue date, for each of the four maturity classes. The market value weight of each selected security is the sum of the market values for all of the issues in the maturity class.

For the 1000 asset type, Bond/Notes, select the two securities with the most recent issue date for each of the twenty maturity/agency combinations. The market value weight for each of the securities is one half the sum of the market values of the securities in the maturity-asset type-agency combination. In the event that there is only one issue available in a maturity-asset type-agency combination, then its market value is also the market value weight.

Data Selection for Real-Time Bond Markets Index (CPMKTB)

The CPMKTB is composed of securities with a maturity of one year or greater from the fixed income markets. The real-time security indexes for the CPMKTL are determined quarterly.

Data Selection for Long Term US Corporate Bonds (CPMKTBCBO)

The CPMKTBCBO is a selection of investment grade US corporate bonds with a maturity of one year or greater. There are two sets of selection criteria that are used for long term corporate bonds. The first applies to bonds with an industry type of 1010, 1020 or 1060. It is a simplified grouping of just three maturity classes and two rating classes. The second applies to bonds with an industry type of 1030, 1040 or 1050. It is the normal grouping of nine maturity classes and four rating classes.

For the “simple” groupings, which apply to industry types 1010, 1020, and 1060, there are three maturity classes and two groups of ratings. As a result, there are six different maturity-ratings combinations. For each industry, two issues are selected from each of the six maturity-rating combinations, resulting in twelve issues per the three industry types and a total of 36 issues.

| Maturity Classes | | Ratings |
|---|---|---|
| 1 to 4 | years | Tier 1 & 2 |
| 4 to 11.5 | years | Tier 3 & 4 |
| 11.5 or more | years | |

For the “normal” groupings, which apply to industry types 1030, 1040, and 1050, there are nine maturity classes and four ratings. As a result, there are 36 different maturity-ratings combinations. For each industry, two issues are selected from each of the 36 maturity-rating combinations, resulting in 72 issues per the three industry types and a total of 216 selected issues from these three industries.

| Maturity Classes | | Ratings |
|---|---|---|
| 1 to 1.5 | years | Tier 1 |
| 1.5 to 2.5 | years | Tier 2 |
| 2.5 to 4 | years | Tier 3 |
| 4 to 6 | years | Tier 4 |
| 6 to 8.5 | years | |
| 8.5 to 11.5 | years | |
| 11.5 to 15 | years | |
| 15 to 25 | years | |
| 25 or more | years | |

Each issue is also assigned a market value weight, which is equal to one half of the sum of the market values for all of the issues in the maturity-rating combination. In the case where there is only one issue within the maturity-rating combination for an industry, then it is the only issue selected and its market value is used as the market value weight.
Data Selection of: Long Term Mortgage Back Securities (CPMKTBMG)

The CPMKTBMG is a selection of mortgage backed securities with a maturity greater than or equal to one year. There are nine maturity classes, nine specific coupon values and nine asset types.

| Maturity Classes | | Coupons | Asset Types |
|---|---|---|---|
| 1 to 1.5 | years | 4.0 | 3000 (FHGOLD-15YR) |
| 1.5 to 2.5 | years | 4.5 | 3020 (FHGOLD-30YR) |
| 2.5 to 4 | years | 5.0 | 3035 (FHGOLD-5YR Balloon) |
| 4 to 6 | years | 5.5 | 3040 (FHGOLD-7YR Balloon) |
| 6 to 8.5 | years | 6.0 | 3205 (FNMA-15YR) |
| 8.5 to 11.5 | years | 6.5 | 3215 (FNMA-30YR) |
| 11.5 to 15 | years | 7.0 | 3235 (FNMA-7YR Balloon) |
| 15 to 25 | years | 7.5 | 3300 (GNMA-15YR) |
| 25 or more | years | 8.0 | 3305 (GNMA-30YR) |

From each of the 729 maturity-coupon-asset type combinations, the two securities with the greatest factor and WAC are selected for that combination. Each of the selected securities is assigned a market value weight that is equal to one half of the total market value for all of the securities within that combination. If there is only one security available, then it is selected and assigned its own market value as the market value weight.
Data Selection for Long Term US Treasury Bonds/Notes (CPMKTBTBO)

The CPMKTBTBO is a selection of treasury bonds and notes with a maturity greater than or equal to one year. The CPMKTLTBO is broken into nine maturity classes:

Maturity Classes

| | |
|---|---|
| 1 to 1.5 | years |
| 1.5 to 2.5 | years |
| 2.5 to 4 | years |
| 4 to 6 | years |
| 6 to 8.5 | years |
| 8.5 to 11.5 | years |
| 11.5 to 15 | years |
| 15 to 25 | years |
| 25 or more | years |

For each of these classes, two issues are selected, the two issues with the greatest value for the Issue Date. Their market value weights are then assigned with half of the total market value for the maturity class to each of the two issues. If there is only one issue within the market class, then it is selected with a market value weight equal to its market value.
Data Selection for Long Term US Federal Agency Bonds (CPMKTBA)

The CPMKTBA is a selection of US Federal Agency issues with a maturity one year or greater. The CPMKTBA is divided into nine maturity classes and six agency categories:

| Maturity Classes | | Agency Categories |
|---|---|---|
| 1 to 1.5 | years | FNMA: Federal National Mortgage Association |
| | | (Fannie Mae) |
| 1.5 to 2.5 | years | FHLMC: Federal Home Loan Mortgage |
| | | Corporation (Freddie Mac) |
| 2.5 to 4 | years | FHLB: Federal Home Loan Banks |
| 4 to 6 | years | FFCB: Federal Farm Credit Banks |
| 6 to 8.5 | years | SLM: Student Loan Marketing Association |
| | | (Sallie Mae) |
| 8.5 to 11.5 | years | Other: Other federal bond issues |
| 11.5 to 15 | years | |
| 15 to 25 | years | |
| 25 or more | years | |

The selection of the CPMKTBA securities is identical to the process used to select securities with asset type 1000 for the CPMKTLA. The agency category “Other” is excluded from the selection process. For each of the 45 remaining maturity-agency combinations, two securities with the most recent issue date are selected and assign a market value weight of one half the total market value for all issues within that maturity-agency combination. In the event that there is only one security with a given maturity-agency combination, it is selected and assigned the market value weight of its own market value.

Although described herein in terms of a preferred embodiment and a number of alternative embodiments, those skilled in the art will recognize that a number of changes can be made to the method of the present invention which do not change the manner in which the steps in the method function to achieve their intended result. All such changes are intended to fall within the spirit and scope of the present invention as set out in the following, non-limiting claims.

What is claimed is:

1. A method for managing data for use in calculating a capital market index comprising the steps of:
identifying data sources for capital market securities;
acquiring securities data from said sources;
standardizing said acquired data using common terminology;
classifing said standardized securities data by market sectors;
subdividing said market sectors by security typology;
formatting said subdivided securities data for storage and computation;
up-dating said subdivided, standardized securities data consistent with market changes;
correcting errors and/or omissions within said security data;
selection a plurality of securities from said corrected securities data in accordance with pre-selected criteria;
applying weights to said corrected, selected securities; and
storing said security and weight data in digital format for subsequent calculation of an index that tracks total returns of the capital market;

2. The method of claim 1 wherein the securities comprising the capital market are selected from public companies with issued stock.

3. The method of claim 2 wherein said securities comprise the securities issued by the top two thousand (2000) companies ranked by market capitalization.

4. The method of claim 1 wherein said securities comprise fixed income securities with a maturity less than one year and Money Market securities.

5. The method of claim 1 wherein said securities are selected from investment grade US corporate bonds with a maturity less than one year.

6. The method of claim 5 wherein said corporate bonds are apportioned into a first and a second maturity class wherein said first maturity class comprises bonds with a maturity from zero to six months and said second maturity class comprises bonds with a maturity from seven to twelve months.

7. The method of claim 6 wherein said first maturity class is divided into a first and second rating wherein said first rating comprises tier one and tier two.

8. The method of claim 6 wherein said second maturity class is divided into a first and second rating wherein said first rating comprises tier three and said second rating comprises tier four.

9. The method of claim 6 wherein the market value weight for a sole issue of a maturity rating combination is the sum of the market values for all of the issues

10. The method of claim 6 wherein for each maturity class and rating combination, a first and second security, each with the most recent issue dates are selected, and the market value weight assigned to each of said issues is one half the total market value for all of the issues in the maturity-rating combination.

11. The method of claim 1 wherein a sub-set of said entities are selected on a date certain from the plurality of United States Treasury Bills.

12. The method of claim 11 wherein the plurality of said Treasury Bills is sub-divided into a first, second, third, and fourth maturity class.

13. The method of claim 12 wherein said first maturity class comprises Treasury Bills maturing in a time period of less than three (3) months after said date certain; said second maturity class comprises Treasury Bills maturing in a time period of at least three (3) but less than six (6) months after said date certain; said third maturity class comprises Treasury Bills maturing in a time period of at least six (6) but less than nine (9) months after said date certain; said fourth maturity class comprises Treasury Bills maturing in a time period of at least nine (9) months but less than twelve (11) months after said date certain; and wherein said selection occurs each month on the fourth business day before the beginning of the following month.

14. The method of claim 11 wherein a first and second issued Treasury Bill are selected from each of the first, second, third and fourth maturity class.

15. The method of claim 12 wherein the first of said Treasury Bills in each of said maturity classes is the issue with the latest maturity date within the class; and wherein the second of said Treasury Bills in each of said maturity classes is that issue with a maturity date intermediate in the three month period defining the class.

16. The method of claim 15 wherein the market value weight of said second issued Treasury Bill of intermediate date maturity in each of said classes is the sum of the market values of the issues in the class with maturity less than or equal to the maturity of the intermediate date issue.

17. The method of claim 15 wherein the weight of said first Treasury Bill is determined by the sum of the market values of the plurality of issues with maturity dates in the class later than the maturity date of said second Treasury Bill.

18. The method of claim 1 wherein the securities comprise treasury bonds and notes.

19. The method of claim 18 wherein said treasury bonds and notes are subdivided into a first class with maturity dates from zero to less than three months.

20. The method of claim 18 wherein said treasury bonds and notes are subdivided into a second class with maturity dates from three months to less than six months.

21. The method of claim 18 wherein said treasury bonds and notes are subdivided into a third class with maturity dates from six months to less than nine months.

22. The method of claim 18 wherein said treasury bonds and notes are subdivided into a fourth class with maturity dates from nine months to twelve months.

23. The method of claim 18 wherein for each of the first, second, third and fourth maturity classes a first and a second issue are selected with the latest issued dates.

24. The method of claim 23 wherein market value weights for each of said first and second selected issues is half of the total market value for said maturity class from which each of said first and second issues are chosen.

25. The method of claim 1 wherein the securities comprise short term U.S. Federal Agency Bonds.

26. The method of claim 25 wherein said securities are subdivided into a first, second, third, fourth and fifth agency category, respectively, Federal National Mortgage Association, Federal Home Loan Mortgage Corporation, Federal Home Loan Banks, Federal Farm Credit Banks, and Student Loan Marketing Association.

27. The method of claim 26 wherein each of said agency categories is further subdivided into an asset type, respectively Bond Notes.

28. The method of claim 27 wherein said asset type is further subdivided into a first, second, third and fourth maturity class, respectively zero to less than three months, three to less than six months, six to less than nine months and nine to twelve months.

29. The method of claim 28 wherein a first and a second security are selected with the most recent issue date for each of the twenty (20) maturity/agency combinations.

30. The method of claim 30 wherein the market value weight for each of said securities is one half the sum of the market values of the securities in the maturity/agency combination unless there is only one issue available in said maturity/agency type combination whereupon the market value of said single issue is the market value weight.

31. The method of claim 1 wherein the securities comprise long term U.S. Corporate Bonds with a maturity of one year or greater.

32. The method of claim 31 wherein said long term bonds are issued by Industry Types comprising consumer goods, consumer service and retail trade and business services.

33. The method of claim 32 wherein said long term bonds are subdivided into a first, second, third and fourth maturity class, respectively one to less than three years, three to less than seven years, seven to less than fifteen years and fifteen years or more.

34. The method of claim 33 wherein each of said maturity classes is further subdivided into a first and a second rating category, respectively Tier 1 and 2 and Tier 3 and 4 combinatorially comprising eight maturity-rating combinations.

35. The method of claim 34 wherein for each industry in said consumer goods, consumer service and retail trade and business services industry types a first and a second issue are selected from each of said industries for each of the eight maturity rating combinations.

36. The method of claim 35 wherein each of said selected issue is assigned a market value weight equal to one-half the sum of the market values for all of the issues in said maturity-rating combination from which said selected issue is taken unless there is only one issue within said maturity-rating combination for an industry whereupon the market value of said selected issue is taken as said issue's market value weight.

37. The method of claim 1 where in said securities comprise long term mortgage backed securities with maturity greater than or equal to one year.

38. The method of claim 37 wherein said securities are subdivided into a first asset type designated FHGOLD-15 year, a second asset type designated FHGOLD-30 year, a third asset type designated FHGOLD-5 year balloon, a fourth asset type designated FHGOLD-7 year balloon, a fifth asset type designated FNMA- 15 year, a sixth asset type designated FNMA-30 year, a seventh asset type designated FNMA-7 year balloon, an eighth asset type designated GNMA-15 year and a ninth asset type designated GNMA 30 year.

39. The method of claim 38 wherein each of said asset types is further subdivided into a first coupon (a certificate evidencing the obligation to pay an installment of interest or a dividend that must be cut and presented to its issuer for payment when it is due) of 4.0, a second coupon of 4.5, a third coupon of 5.0, a fourth coupon of 5.5, a fifth coupon of 6.0, a sixth coupon of 6.5, a seventh coupon of 7.0, an eighth coupon of 7.5 and a ninth coupon of 8.0.

40. The method of claim 39 wherein each asset type/coupon value is further subdivided into a first maturity class of one to less than 1.5 years, a second maturity class of 1.5 years to less than 2.5 years, a third maturity class of 2.5 to less than 4 years, a fourth maturity class of 4 to less than 6 years, a fifth maturity class of 6 to less than 8.5 years, a sixth maturity class of 8.5 to less than 11.5 years, a seventh maturity class of 11.5 to less than 15 years, an eighth maturity class of 15 to less than 25 years and a ninth maturity class of 25 years or greater.

41. The method of claim 40 wherein from each of the 729 maturity-coupon-asset type combinations, a first and second securities with the greatest factor (a decimal value reflecting the proportion of the outstanding principal balance of a mortgage security, which changes over time, in relation to its original principal value) and weighted average coupon (the weighted average of the gross interest rates of mortgages underlying a pool as of the pool issue date; the balance of each mortgage is used as the weighting factor) are selected for that combination.

42. The method of claim 41 wherein each of the selected securities in the asset type/coupon value/maturity class group is assigned a market value weight that is equal to one-half of the total market value for all of the securities with that asset type/coupon value/maturity combination, unless there is only one security in the group whereupon said single security is selected and assigned its own market value as the market value weight.

43. The method of claim 1 wherein the securities comprise long term U.S. Treasury Bonds/Notes with maturity greater than or equal to one year.

44. The method of claim 43 wherein said selected securities are subdivided into a first maturity class from 1 to less than 1.5 years, a second maturity class from 1.5 to less than 2.5 years, a third maturity class from 2.5 to less than 4 years, a fourth maturity class from 4 to less than 6 years, a fifth maturity class from 6 to less than 8.5 years, a sixth maturity class from 8.5 to less than 11.5 years, a seventh maturity class from 11.5 to less than 15 years, an eighth maturity class from 15 to less than 25 years and a ninth maturity class from 25 years or more.

45. The method of claim 44 wherein a first and second issue with the greatest value for the issue date are selected from each of said maturity classes.

46. The method of claim 45 wherein for each of said first and second issue a market value weight is assigned with half of the total market value for the maturity class unless there is only one issue within the market class whereupon said single issue is selected with a market value weight equal to its market value.

47. The method of claim 1 wherein said securities comprise long term U.S. Federal Agency Bonds with maturity of one year or greater.

48. The method of claim 47 wherein said selected securities are subdivided into a first agency category designated as the Federal National Mortgage Association, a second agency category designated as the Federal Home Loan Mortgage Corporation, a third agency category designated as the Federal Home Loan Bank, a fourth agency category designated as the Federal Farm Credit Banks, and a fifth agency category designated as the Student Loan Marketing Association.

49. The method of claim 48 wherein said selected securities are subdivided into a first maturity class from 1 to less than 1.5 years, a second maturity class from 1.5 to less than 2.5 years, a third maturity class from 2.5 to less than 4 years, a fourth maturity class from 4 to less than 6 years, a fifth maturity class from 6 to less than 8.5 years, a sixth maturity class from 8.5 to less than 11.5 years, a seventh maturity class from 11.5 to less than 15 years, an eighth maturity class from 15 to less than 25 years and a ninth maturity class from 25 years or more.

50. The method of claim 49 wherein for each of the 45 agency-maturity combinations a first and a second security with the most recent issue dates are selected and assigned a market value weight of one-half the total market value for all issues within that agency-maturity combination unless there is only one security within said agency maturity combination whereupon the single security is assigned the market value weight of its own market value.

51. The method of claim 1 wherein said preselected criteria include one or more of the following criteria:
the size of the market capitalization of the corporation issuing the security;
the maturity date of the security;
the rating of the security;
the issuing entity;
the entity backing the security;
the asset type;
the security coupon value; and/or
the domicile and governance of the issuer of the security.

52. A method for correcting omissions and/or errors in data describing securities comprising the steps of:
identifying securities with identical market characteristics and/or different unique identifiers;
correcting said identifiers to accurately associate with the appropriate unique security;
comparing daily share outstanding values, daily closing price values and equity split event information with each other to determine the correct date for said split event;
correcting said daily shares outstanding and equity split information;
correcting values in a data series wherein anomalous entries occur which are inconsistent with the remainder of data in said data series;
correcting descriptive data by testing the consistency of any single element when considered as part of the whole; and
correcting fixed income prices by filling in gaps and/or vacancies in primary sources data using values derived from a secondary source.

53. A method for standardizing data describing securities comprising the steps of:
enumerating the individual fields with a selected vendor's data;
evaluating each of said fields for use within the database; and
utilizing a specific mapping transforming said vendor data into data labels created for said database where said mapping comprises identifying all terms describing a given entity and assigning a preferred single appellation to said entity for use in said database.
